(19) United States
(12) Patent Application Publication
(10) Pub. No.: US 2019/0087804 A1
(43) Pub. Date: Mar. 21, 2019

(54) REAL TIME CHECKOUT AUCTION

(71) Applicant: Vincent Cluxton, Colorado Springs, CO (US)

(72) Inventor: Vincent Cluxton, Colorado Springs, CO (US)

(21) Appl. No.: 15/705,945

(22) Filed: Sep. 15, 2017

(51) Int. Cl. G06Q 20/22; G06Q 30/02

(52) U.S. Cl. CPC G06Q 20/227; G06Q 30/0207

(57) ABSTRACT

As a user considers a purchase or begins a purchase transaction, the user's payment service contacts subscribed issuers to request related offers or discounts for the purchase. Based on the offers or discounts, the user may select between payment instruments for completing the transaction. The issuers may use various heuristics to develop the offers or discounts, including user purchase history, user payment history, type of purchase, value of purchase, or others. In an extension of this embodiment, various loyalty programs may also be contacted for offers related to the proposed purchase.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Companies that provide financial services to consumers are in competition for share of mind of a consumer, vying to gain “top-of-wallet” status for their payment instrument, such as a credit card. However, consumers may not be in a position to benefit from this competition.

### SUMMARY

In an embodiment, as a consumer begins a transaction, a payment service contacts issuers with which the consumer has payment instruments so that the issuers can determine if they wish to compete for the transaction, and if so, what to offer. In some cases, a predetermined set of offers may be used from which to make a selection. In other cases, heuristics may be applied to generate a custom offer for a particular transaction based, in various embodiments, on customer traits, transaction type, purchase type, purchase value, or other factors.

### BRIEF DESCRIPTION OF THE DRAWINGS

The figures depict a preferred embodiment for purposes of illustration only. One skilled in the art may readily recognize from the following discussion that alternative embodiments of the structures and methods illustrated herein may be employed without departing from the principles described herein.

FIG. 1 is a block diagram of entities participating in a real time checkout auction system in accordance with the current disclosure;

FIG. 2 is a block diagram of an alternate embodiment of the system of FIG. 1;

FIG. 3 is a block diagram of an exemplary embodiment of a payment platform participating in a real time checkout auction system;

FIG. 4 is a block diagram of an exemplary embodiment of an issuer platform participating in a real time checkout auction system;

FIG. 5 is a block diagram of an alternate embodiment of an issuer platform participating in a real time checkout auction system;

FIG. 6 is a flowchart of a method of performing a real time checkout auctions; and

FIG. 7 is an exemplary user screen depicting user selection in an embodiment of real time checkout auction.

### DETAILED DESCRIPTION

Many financial instrument issuers offer rewards for various purchase types. For example, one issuer may offer a rebate on purchases of gasoline, while another may discount on groceries. Purchases matching these categories are tallied at the end of the billing period and an appropriate statement credit or cashback award are detailed on the next statement. In many cases, the consumer may not be aware of the possible offers or may not be in a position to evaluate the impact of selecting one card vs. another. A system 100 supports check out options related to offers from different entities such as issuers and merchants related to a current purchase so that the consumer can see in real time the options available from different issuers and the impact selecting one payment option over another. In these embodiments, the offers presented may be a simple recitation of existing offers, although it may be impossible for a consumer to research, categorize, and determine applicability of the various existing offers to the current purchase in the real time associated with making a payment decision.

In various other embodiments, however, the offers may include more than existing offers but may include transaction-specific offers that are generated by issuers or merchants in real time. These offers may be generated based on user purchase history, user payment history, type of purchase, value of purchase, or others. The use of heuristics to monitor consumer behavior, especially in response to current and previous offers may help refine the selection of appropriate offers.

Examples of some offer types, both existing and generated in real time, may include discounts on the current transaction, an interest-free period to pay off the transaction, bundling an additional item to qualify for a specific discount or incentive, or applying a discount to a future purchase using that financial instrument. While these are simply examples of a broad range of offers, there is a nuance associated with these and other offers relative to the amount of discounts, the value of bundled items, the level of future discounts, the level of qualifying purchases, etc., that create a significant range of adjustments for influencing behaviors. Beyond the broader consumer behavior, the issuers and merchants may also be influenced when making an offer by the specifics of the consumer, especially when making real time, transaction-specific offers. For example, the offer-maker may want to target a particular demographic of consumer to its brand, or in another embodiment, away from its brand. Another offer-side motivation be associated with moving into a new geographic region where a rapid buildup of consumers may be the goal.

When an offer is selected, the selected offer provider gains insight into what is effective while those parties whose offer was not selected also have valuable feedback on what is not effective. That is, both selected and not-selected offers may be used to refine behavior models for generation of future offers, both standing offers and those generated in real time,

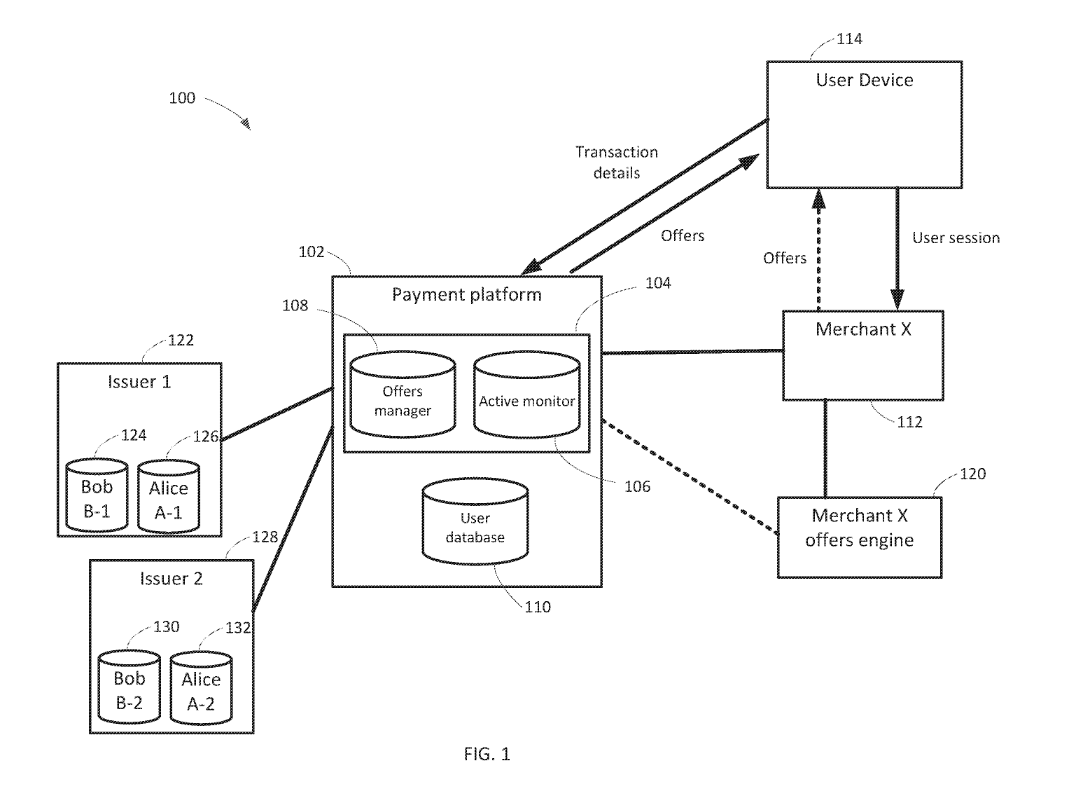

Turning to FIG. 1, a payment platform 102 operates on behalf of a consumer to store credit card information for a variety of issuers and also to provide a convenient service for filling in forms such as email and mailing addresses during online order entry. The consumer may activate the payment platform 102 on a checkout page or cart page of a merchant 112. At this point in the transaction, the consumer/user may not have committed to completing the current transaction and in general has not committed to a particular payment instrument should he or she decide to complete the transaction.

The payment platform 102 may include an offers processor 104 which itself may include an active monitor 106 and an offers module 108. The active monitor 106 may receive transaction information from a payment page of a merchant 112 or directly from a user device 114 that may be connected to the merchant 112 via a user session. The offers processor 104 may retrieve user information from a user database 110. The user information may include issuers from which the user can select for completion of the transaction.

The payment platform 102 may be connected to a plurality of issuer platforms associate with different payment instrument issuers including a first issuer platform 122 and a second issuer platform 128 with which the consumer has affiliations. The payment platform may be connected to a much larger number of issuers or may be connected to virtually all issuers through a payment network (not depicted), such as Visa. For the sake of convenience, only issuer platforms 122 and 128 are depicted, each having accounts for multiple consumers. Issuer platform 122 has accounts 124 and 126 for Bob and Alice, respectively. Similarly, issuer platform 128 also has accounts 130 and 132 for Bob and Alice respectively.

In an embodiment, the merchant 112 may also have an offers engine 120. The merchant's offers engine 120 may engage a consumer, who may or may not have an account with the merchant 112, in an attempt to convince the consumer to select the merchant's branded card for the transaction. In an embodiment, the merchant offers engine 120 may route the offer through the payment platform 102 in order to gain access to a user offers screen generated by the payment platform 102, as discussed more below. The operation of the system 100 and more particularly the payment platform 102 and issuers 122, 128 is described in more detail below.

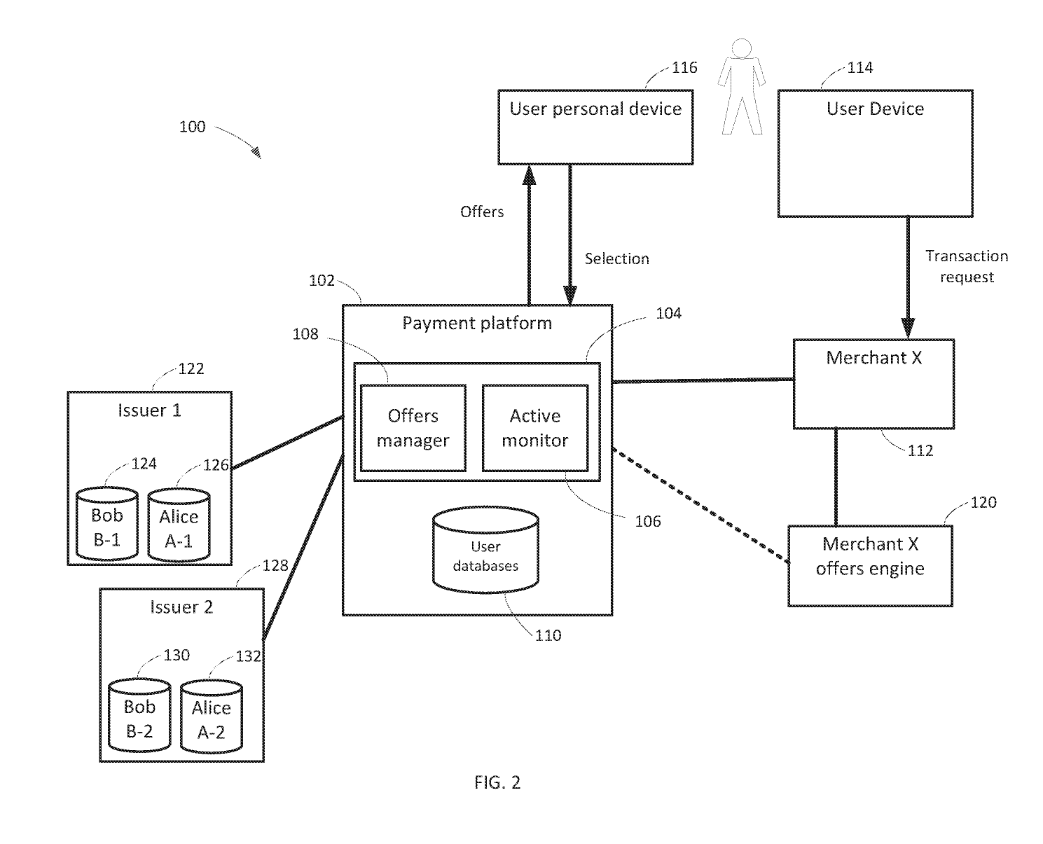

FIG. 2 may be an alternate embodiment of the system 100. In this embodiment, the user may interact with the merchant 112 via a first user device 114 while the offers are received by the user via a second user device 116. In one possible alternate environment, the first user device 114 may be a desktop or laptop computer and the second user device 116 may be a handheld device such as a smartphone or tablet. The use of separate devices 114 and 116 may be present different technical problems as additional communication channels and additional devices are used.

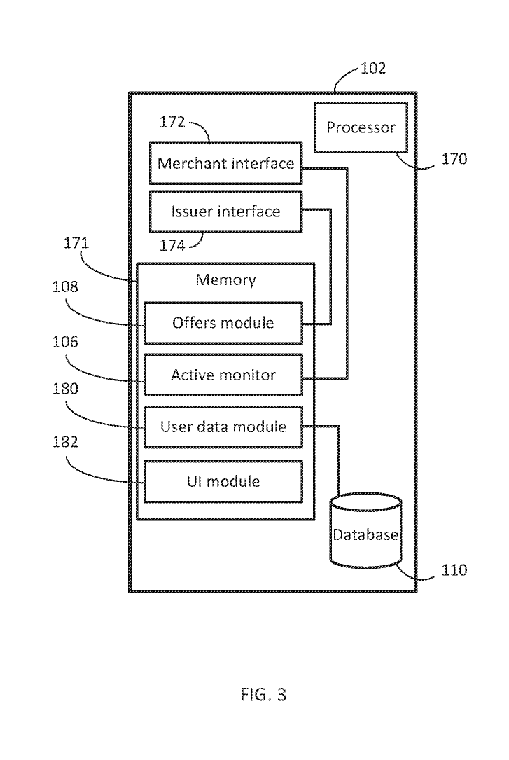

FIG. 3 may be a block diagram of an exemplary payment platform 102 configured for operation in the system 100 supporting real time checkout auctions. The payment platform 102 may include a processor 170 and a memory 171. The payment platform 102 may also include a merchant interface 172 and an issuer carrying out communication between those two entities. For example each interface 172, 174 may include various communication protocol requirements as well as authentication and encryption of data being communicated between the payment platform 102 and those entities.

The memory 171 may include various modules for implementing the system 100 carried out via payment platform 102. These modules may include an offers module 108 that connects with the issuer interface 174 and processes offers received from the issuers 122, 128. The memory 171 may also include an active monitor 106 that monitors in-process transaction information received from merchants and/or the user device 114.

A user data module 180 may collect information about the user from the database 110. The user information may be used for multiple purposes, one of which may be determining which issuers are viable for participating in the current transaction. Another aspect of user data may be platform and preference information related to the presentation of offers to the user during the transaction completion process. Related to the platform and preference information, a user interface module 182 may take data received from issuers via the of the offers module 108 and generate a display update that may be communicated to the user device 114 or the user device 116 depending on the system configuration.

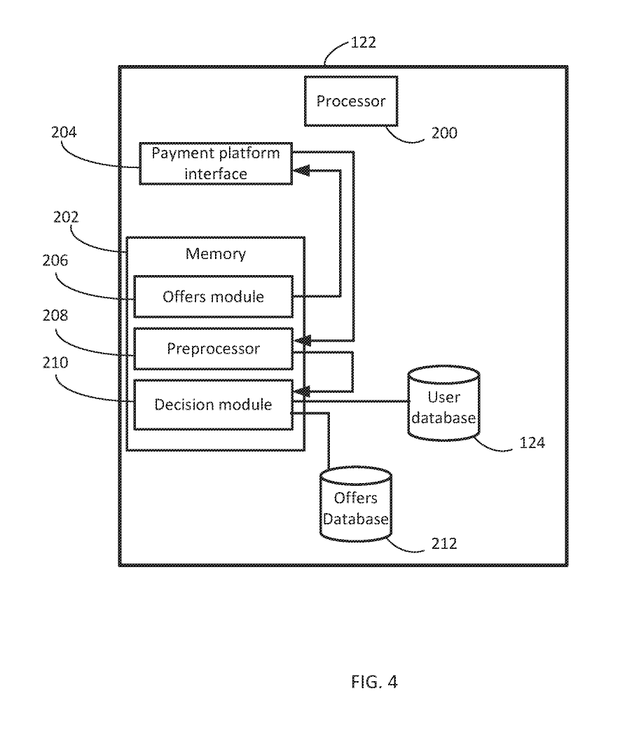

A simplified and exemplary block diagram of an issuer platform 122 for participating in the real time auction system 100 may be illustrated in FIG. 4. The issuer platform 122 may include a processor 200 that executes instructions stored in a memory 202. The issuer platform 122 may include a payment service interface 204 that supports communication with the payment platform 102 and more specifically with the issuer interface 174 of the payment platform 102. The payment platform interface 204 may support a messaging protocol, authentication, encryption, and other functions associated with secure communication with the payment platform 102.

A preprocessor 208 may accept data received via the payment platform interface 204 and parse details of the transaction, including merchant, product, price, as well as consumer details provided by the payment platform 102 such as personal account number or other identifiable information. The preprocessor 208 may format the received data for consumption by the decision module 210. For example, the preprocessor 208 may extract data from a shopping cart to extract individual purchase items, merchant data, prices, etc. The preprocessor 208 may also receive the user identification information and combine it with the extracted cart data in a standard format so that the decision module 210 may operate on the data in a consistent format. Because the system in some embodiments works in real time, it may be desirable to keep exception processing to a minimum, so preprocessing and early identification of missing or malformed data may be valuable. For the purpose of this disclosure, real time may be considered a delay that does not impact the purchase decision of a user during the cart review/check out process. For example, a delay of several seconds may not be noticeable, depending on other variables such as the speed of the user device, network data rate, latency in the network connection, number of correlated items being served, such as advertisements, etc. In contrast, a delay of several minutes may cause a consumer to abandon the purchase or at least forgo waiting for offers and move to a next step in the process.

The decision module 210 may take the data presented by the preprocessor 208, or raw data if preprocessing is not required, and may then look up information about the user in the user account database 124. This information may include information known to the issuer 122 such as typical user spend, volume and velocity of purchases, payment history, acceptance of previous offers, to name a few. The decision module 210 may then consult an offers database 212 from which to select an appropriate offer. There may be rules or algorithms associated with the selection of an offer. For example, in one embodiment, offers may be made in tiers, so that the best customers receive the most attractive offers while in another embodiment, customers with a poor payment history may not be eligible for any offers. In another case, customers who use the issuer infrequently may receive the most attractive offers while high volume customers are given small incentives or none at all. Once the decision module 210 has selected an offer, the information pertaining to the offer may be formatted, if necessary, and sent to the payment platform interface 204 for forwarding to the payment platform 102.

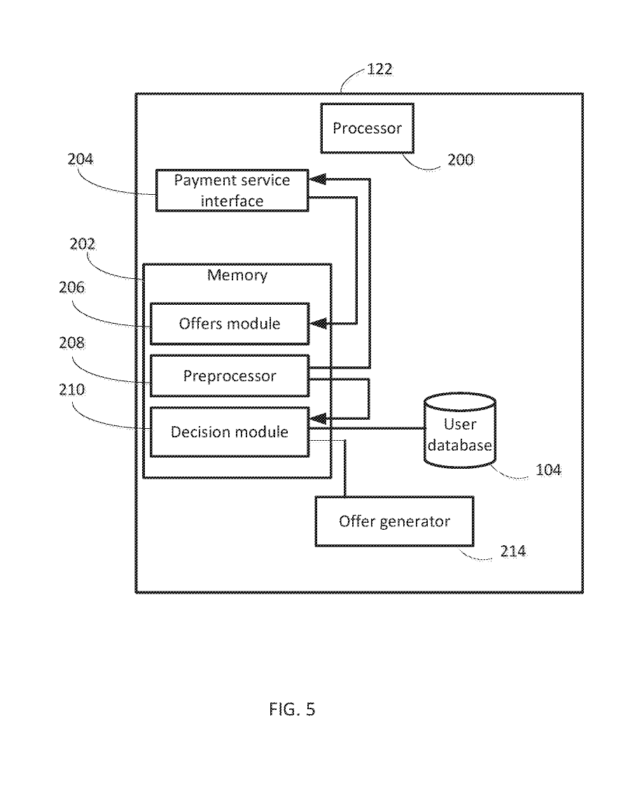

An alternate embodiment of the issuer platform 122 may be illustrated in FIG. 5. The elements of the embodiment of FIG. 5 may be the same as those in FIG. 4 with the exception that instead of a database 212 of pre-generated offers, an offer generator 214 may evaluate the purchase and user data and in real time and generate an offer for the particular transaction being considered. The offer generator 214 may be an artificial intelligence/machine learning system that evaluates the responses to previous offers and the associated input characteristics to generate increasingly more refined offers that attempt to improve the conversion rate of transactions made by that user and for that type of user. More specifically, the offer generator 214 may store and analyze past offers and responses to refine offers in the future in the hope of obtaining the desired response.

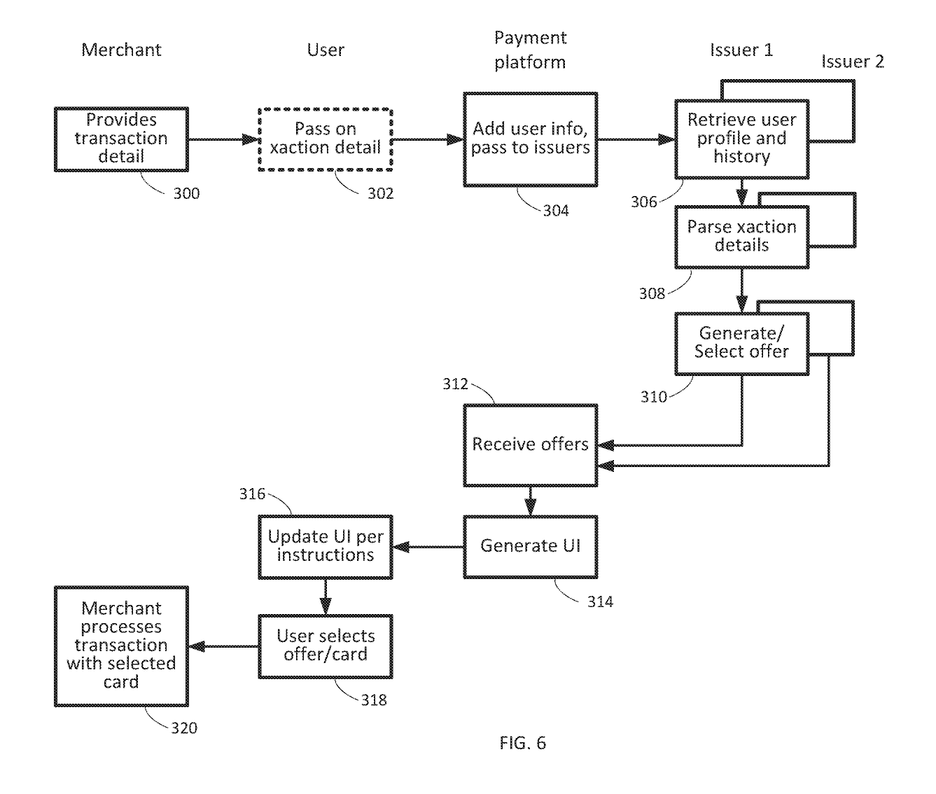

FIG. 6 may be a flow diagram of a method of performing real time checkout auctions in accordance with the current disclosure. At a block 300, a merchant 112 may provide proposed transaction details to a payment platform 102. In an embodiment, the proposed transaction may be captured via a shopping cart of the merchant 112. In one embodiment, the merchant may pass transaction details directly to the payment platform 102 but in another embodiment, transaction details may be captured by the user at a user device 114 so that the transaction details may be passed from the user device 114 to the payment platform 102 as indicated at block 302. In this latter embodiment, the transaction details may be captured by an app or plug-in supplied by the payment platform 102 that executes on the user device 114 at least in part to support the real time checkout auction process.

At block 304, the payment platform 102 may add user information to the transaction details as discussed above, and pass that information on to one or more issuers 122, 128 at block 306. At block 306, each issuer involved may parse the transaction details as necessary to support selection for generation of an offer at block 310. The parsing may be automated and may operate according to a set of rules or an algorithm. Further, the parsing may use artificial intelligence to store past offers and responses to create offers in the future that are optimized toward receiving a desired response. For example, one algorithm may calculate an increasing percentage of discount as a customer's attractiveness increases and the time since last use of the issuer's payment instrument. In an embodiment, a customer may be more attractive if he or she carries a balance, makes regular payments, and has a credit rating above a certain value.

The selected offer may be returned to the payment platform 102, along with all other offers from other issuers and/or from the merchant 112 itself, at block 312. Using details about the user device 114 that may be stored in a user database 110 or extracted from communication with the user device 114, a user interface package may be generated at block 314 and sent to the user device 114. The user interface package may include code, such as JavaScript, that may be used at the user device 114 to present the offers in a format that can be readily selected by the user at the time the transaction is completed. The user interface may be designed to maximize efficiency and accuracy of the offer process and may attempt to ensure the transaction occurs such that the user may be able to easily select any offers that may be available.

At block 316, the user device 114 may receive the user interface package and display the information according to the instructions received. The user may then select an offer and/or a payment instrument represented by the offer at block 318. Again, the user interface may be designed in a way to ensure one of the many possible offers is efficiently and accurately selected and applied with extensive work by the user searching for offers.

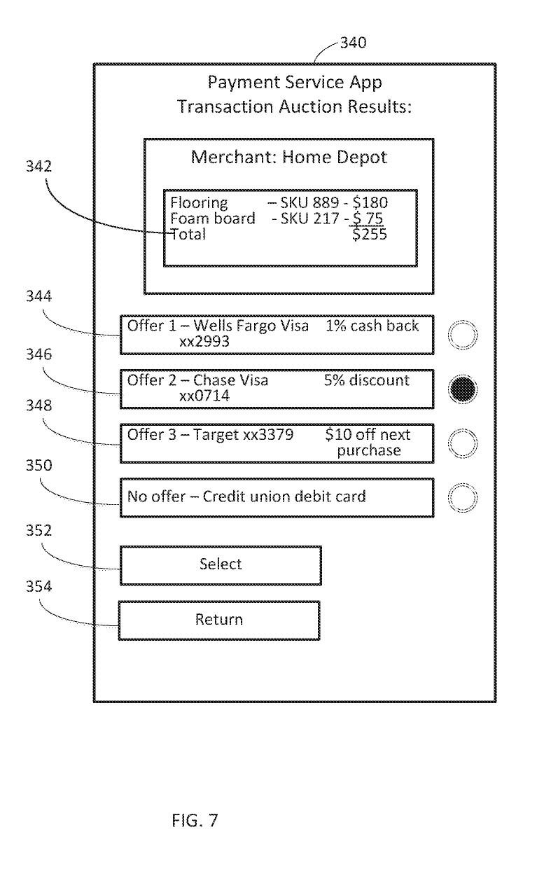

Turning briefly to FIG. 7, an exemplary screen shot 340 of a user device 114 or 116 may be illustrated. In this example, a screen element 342 may provide a summary of the transaction while screen elements 344, 346 and 350 depict various responses from issuers. Of note, the response from the credit union represented by screen element 350 indicates that no offer is being made, but for completeness the payment platform 102 may include that payment instrument for possible selection by the user based on another criteria. Offer 348 is from a branded payment instrument from another retailer who may be attempting to solidify the top of wallet nature of its card even though the purchase is being made elsewhere. In the interest of maintaining the brand loyalty, its offer may not be for the current purchase but instead is applicable to a future purchase at the other retailer. Screen elements 352 and 354 allow the user to continue with the selected payment instrument or exit without making a selection. In this illustration, the selection is made via radio buttons, here indicating that the offer 346 has been selected.

In some embodiments, art related to the offers may also be included. For example, in FIG. 7, the Wells Fargo Visa may include and images, fonts, colors, haptic feedback or sounds that may remind a user of the specific Wells Fargo account in question. Similarly, the Chase Visa may include different images, fonts, colors, haptic feedback, sounds, etc. that a user may recognize as being related to the Chase Visa.

Returning to FIG. 6, after receiving the selection from the user at block 318, the merchant 112 may continue with the purchase transaction at block 320. In some embodiments, the selection may elicit a response from the system that is controlled by the offeror such as images, fonts, colors, haptic feedback, sounds, etc. which a user may recognize as being related to the specific offer.

It should be noted that users may also have access to a user interface (not shown) to modify the system to their own personal desires. For example, a user may not desire haptic feedback and the user may be able to eliminate haptic feedback. Similarly, the user may desire to have the offers displayed in a specific order such as in alphabetical order or in cash back percentage order. Further, some users may desire a large user interface of offers while other users may desires a small user interface of offers.

In some embodiments, the offeror, for example, an issuer 122 or merchant 112, may have control of the user interface. In some embodiments, the offeror may want their offer to stand out and the user interface may be a branded type user interface. In other embodiments, the offeror may want the offer user interface to appear similar to the payment interface such that users will not be startled during a transaction.

Finally, the system may have a set of rules and algorithms that control the user interface of offers and the modifications by the user and offerors may be governed by the rules. The rules may be known and may be public such that outsiders can easily interact with the system. The rules may be designed to make the offers appear to a user as if the offers were part of the payment system. The system 100 may have a separate computing device such as a server which controls the user interface which applies the user interface rules and ensure the user interface seen by a user is communicated efficiently and accurately.

Similarly, the offerors may have a user interface (not shown) which provides a dashboard of feedback on how the offers of the offeror are being used. In some embodiments, the offers may be too successful and the desired financial results may not be reached. In other embodiments, the offers may not be successful enough and the dashboard may indicate the failure of the offers. In some embodiments, advanced tools may allow an offeror to set goals for an offer and the system may automatically adjust the offers such that the results of the offer move toward the goal. As yet another example, the offeror may desire to target a specific target audience and the results of the targeting may be displayed. Of course, the user interface may be adjustable by the offeror to suit the desires of the offeror such that the offers work as intended.

A technical effect of a system and method in accordance with the current disclosure is generation of user interfaces at a first device for changing the functional capabilities at a second device to receive a user selection and continue the transaction. The merchant wants to keep the customer at its website rather than have the user interrupt a session to consider various discount and cash back offers that may be available.

A system and method in accordance with the current disclosure benefits all parties involved. The customer is able to select an offer from among competing offers. The merchant benefits by having control of the customer during the entire checkout process and the user's perception that shopping with the merchant receives an award. Further, the user may increase his or her spend based on the ability to preview the discount or offer before completing the transaction. An issuer is able to improve customer loyalty by providing attractive offers. Finally, the payment platform generates loyalty by being perceived as the conduit to the offers.

The figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

I claim:

1. A method of selecting an offer for a user, the method comprising:
receiving, at an issuer platform from a payment service, a detail of a potential transaction of the user;
receiving, at a decision engine, a profile of the user;
receiving, at the decision engine, a purchase history of the user;
parsing, at a preprocessor, the detail of the potential transaction to determine a vendor;
parsing, at the preprocessor, the detail of the potential transaction to determine an item category;
parsing, at the preprocessor, the detail of the potential transaction to determine a price;
receiving, at the decision engine, the vendor, the item category, and the price;
selecting, via the decision engine, an offer from a plurality of offers related to the potential transaction; and
sending the offer to the payment service.

2. The method of claim 1, further comprising:
generating, via an offers engine, the plurality of offers based on criteria related to at least one aspect of the detail of the potential transaction.

3. The method of claim 1, further comprising receiving, at the payment service, the detail of the potential transaction of the user.

4. The method of claim 1, further comprising retrieving, at the payment service, all issuers associated with the user.

5. The method of claim 1, further comprising sending the detail of the potential transaction to each issuer associated with the user.

6. The method of claim 1, further comprising receiving, at the payment service, an offer from the vendor, the offer related to the potential transaction.

7. The method of claim 6, wherein the offer is one of a discount or a future value.

8. A system for providing real-time offers during a transaction, the system comprising:
a first processor and first memory, the first memory storing executable instructions that implement a payment service including:
a transaction data module that receives information corresponding to a proposed transaction, the information including a user identifier corresponding to a user, a vendor, a product, and a price;
a user module that queries a first database using the user identifier to determine financial instruments associated with the user;
an offers module that communicates with respective issuer platforms corresponding to the financial instruments regarding offers related to the potential transaction; and
a UI module that prepares a display update for a device viewable by the user, the display update based on offers received via the offers module.

9. The system of claim 8, further comprising:
a second processor and a second memory, the second memory storing executable instructions that implement an issuer offers service including:
a module that communicates with the payment service to receive the information corresponding to the proposed transaction;
a module that evaluates characteristics of the user;
a module that evaluates characteristics of the proposed transaction; and
a module that selects an offer related to the proposed transaction based on the characteristics of the user and the characteristics of the proposed transaction and returns the offer via the module that communicates with the payment service.

10. The system of claim 9, further comprising an offer generator module that selects the offer is further programmed to generate one or more offers based on a heuristic analysis of the proposed transaction and the user.

11. The system of claim 9, wherein the module that selects the offer makes a selection from a plurality of previously prepared offers.

12. The system of claim 9, wherein the module that evaluates the characteristics of the user executes an artificial intelligence-based process to categorize the user among a plurality other users.

13. The system of claim 9, wherein the module that selects the offer uses an artificial intelligence-based process to assess the properties of an offer that increase a probability of being selected by the user.

14. The system of claim 8, further comprising:
a point of sale (POS) terminal including:
a third processor and third memory, the third memory storing executable instructions that implement:
a module for collecting the information corresponding to the proposed transaction;
a module for communicating the information to the payment service;
a payment instrument acceptance device; and
a display.

15. The system of claim 14, wherein the display update is received at the POS terminal and presented to the user on the display, the POS terminal further including a user input device for accepting one of the offers.

16. The system of claim 8, wherein the display update is received at a personal device of the user and the user selects one of the offers via a user interface of the personal device.

17. A method of preselecting a payment instrument for a proposed transaction, the method comprising:
collecting transaction data for the proposed transaction by a user at point of sale device;
sending the transaction data to a payment service;
sending, from the payment service, the transaction data to a plurality of issuer platforms;
receiving, at the payment service, one or more offers from the issuer platforms related to the proposed transaction;
sending the one or more offers to a display device accessible to the user; and
selecting a payment instrument associated with an issuer having a favorable offer.

18. The method of claim 17, further comprising:
displaying the one or more offers at the point of sale device, wherein the selecting of the payment instrument occurs at the point of sale device at the time of execution of the proposed transaction.

19. The method of claim 17, further comprising:
displaying the one or more offers at a personal device of the user, wherein the user selects a payment instrument associated with a favorable offer at the point of sale terminal at the time of execution of the proposed transaction.

20. The method of claim 19, further comprising:
displaying the one or more offers at a personal device of the user, wherein the user selects a payment instrument associated with a favorable offer via a payment application on the personal device at the time of execution of the proposed transaction.
